(19) United States
(12) Patent Application Publication
(10) Pub. No.: US 2026/0260439 A1
(43) Pub. Date: Sep. 3, 2026

(54) VIRTUAL CONTENT ADJUSTMENT

(71) Applicant: QUALCOMM Incorporated, San Diego, CA (US)

(72) Inventors: Gerlinde EMSENHUBER, Hallein (AT); Markus TATZGERN, Bad Vigaun (AT)

(21) Appl. No.: 19/069,158

(22) Filed: Mar. 3, 2025

(51) Int. Cl. G06T 19/20; G06T 7/40; G06T 7/90; G06T 19/00

(52) U.S. Cl. CPC G06T 19/20; G06T 7/40; G06T 7/90; G06T 19/006; G06T 2210/62; G06T 2219/2004; G06T 2219/2012; G06T 2219/2016

(57) ABSTRACT

Systems and techniques are described herein for rendering virtual content. For example, a computing device can process a first measure of a first sensor data representation of an environment to determine a first plurality of characteristics associated with the environment based on at least one of a gradient magnitude, texture, luminance, or color of the environment; determine a second measure of characteristics of virtual content based on at least one of gradient magnitude, texture, luminance, or color of the virtual content; compare the first measure of the first sensor data representation and the second measure of the characteristics of the virtual content; and adjust the virtual content based on the comparison of the characteristics of the virtual content to the first plurality of characteristics to generate updated virtual content.

### FIELD

Aspects of the present disclosure generally relate to extended reality (XR). For example, aspects of the present disclosure relate to virtual content adjustment for XR systems.

### BACKGROUND

XR technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) can include a display allowing a user to view a real-world environment through a display of the HMD (e.g., a transparent display). In such an example, the HMD can include a camera (e.g., a scene-facing camera) to capture images of the real-world environment. The XR HMD can display virtual content in the user's field of view by overlaying the virtual content on a user view of a real-world environment (e.g., the view through the scene-facing camera). In dynamic environments, (e.g., an environment with differences or changes in lighting, perspectives, textures, etc.) virtual content can be difficult to render legibly in part due to differences and changes in visual characteristics of the environment and the virtual content.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for rendering virtual content is provided. The apparatus includes at least one memory and at least one processor coupled to the at least one memory and configured to: process a first measure of a first sensor data representation of an environment to determine a first plurality of characteristics associated with the environment based on at least one of a gradient magnitude, texture, luminance, or color of the environment; determine a second measure of characteristics of virtual content based on at least one of gradient magnitude, texture, luminance, or color of the virtual content; compare the first measure of the first sensor data representation and the second measure of the characteristics of the virtual content; and adjust the virtual content based on the comparison of the characteristics of the virtual content to the first plurality of characteristics to generate updated virtual content.

In some aspects, a method for rendering virtual content is provided. The method includes: processing a first measure of a first sensor data representation of an environment to determine a first plurality of characteristics associated with the environment based on at least one of a gradient magnitude, texture, luminance, or color of the environment; determining a second measure of characteristics of virtual content based on at least one of gradient magnitude, texture, luminance, or color of the virtual content; comparing the first measure of the first sensor data representation and the second measure of the characteristics of the virtual content; and adjusting the virtual content based on the comparison of the characteristics of the virtual content to the first plurality of characteristics to generate updated virtual content.

In some aspects, a non-transitory computer-readable medium is provided having stored thereon instructions that, when executed by at least one processor, cause the at least one processor to: process a first measure of a first sensor data representation of an environment to determine a first plurality of characteristics associated with the environment based on at least one of a gradient magnitude, texture, luminance, or color of the environment; determine a second measure of characteristics of virtual content based on at least one of gradient magnitude, texture, luminance, or color of the virtual content; compare the first measure of the first sensor data representation and the second measure of the characteristics of the virtual content; and adjust the virtual content based on the comparison of the characteristics of the virtual content to the first plurality of characteristics to generate updated virtual content.

In some aspects, an apparatus for rendering virtual content is provided. The apparatus includes: means for processing a first measure of a first sensor data representation of an environment to determine a first plurality of characteristics associated with the environment based on at least one of a gradient magnitude, texture, luminance, or color of the environment; means for determining a second measure of characteristics of virtual content based on at least one of gradient magnitude, texture, luminance, or color of the virtual content; means for comparing the first measure of the first sensor data representation and the second measure of the characteristics of the virtual content; and means for adjusting the virtual content based on the comparison of the characteristics of the virtual content to the first plurality of characteristics to generate updated virtual content.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating components of a user device computing system, in accordance with aspects of the disclosure;

FIG. 2 is a block diagram illustrating an example of a head mounted display (HMD) rendering virtual content, in accordance with aspects of the disclosure;

FIG. 3 is a block diagram illustrating an example of virtual content placement in an environment, in accordance with aspects of the disclosure;

FIGS. 4A-4C are block diagrams illustrating example virtual content placement in an environment, in accordance with aspects of the disclosure;

FIG. 5 is a block diagram illustrating an example adjustment to virtual content, in accordance with aspects of the disclosure;

FIG. 6 is a block diagram illustrating example adjustments to virtual content, in accordance with aspects of the disclosure;

FIG. 7 is a flow diagram illustrating an example of a process for rendering virtual content, in accordance with some examples; and

FIG. 8 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. For example, AR content can include adding a heads-up display (HUD) providing informational virtual content to users regarding their environment. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment (e.g., an AR environment, VR environment, and/or MR environment) can be interacted with in a seemingly real or physical way. For example, as a user experiencing an AR environment (e.g., an augmented version of a real-world environment) moves in the real world, rendered virtual content (e.g., images rendered in a virtual environment during an AR experience) also changes, giving the user the perception that the user is moving within the AR environment. For example, a user can turn left or right, look up or down, and/or move forwards or backwards, thus changing the user's point of view of the AR environment. The AR content presented to the user can change accordingly, so that the user's experience in the AR environment is as seamless as it would be in the real world. Similar experiences can be presented in VR and/or MR environments.

In some cases, an XR system can match the relative pose and movement of objects and devices in the physical world. For example, the XR system can use tracking information to calculate the relative pose of devices, persons, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

In some examples, an XR device can include an optical “see-through” or “pass-through” display (e.g., see-through or pass-through AR HMD or AR glasses), allowing the XR device to display virtual content (e.g., AR content) directly onto a real-world view without displaying video content. For example, a user can view physical objects through a display (e.g., glasses or lenses), and the XR device can display AR content onto the display to provide the user with an enhanced visual perception of one or more real-world objects.

AR (or XR) for optical see-through (OST) head-mounted displays (HMD) can be utilized to overlay helpful information to support users in various tasks. While overlaid information can include 3D content and guidance visualizations, users also require more traditional information representations to interact with the data and system parameters. For example, virtual content such as text boxes, videos, or static images can be used by users such as providing a video tutorial for how to perform a task, providing an image of item to be found, or providing written instructions in text. In some examples, the virtual content can be mounted to objects, surfaces, or locations in an environment. In other examples, the virtual content can be mounted to a user (e.g., travel with the user as the user moves in the environment).

In some examples, the XR device can include one or more optical sensors (e.g., cameras). In such an example, the XR device can include one or more scene-facing optical sensors and ranging sensors (e.g., multiple cameras, light detection and ranging (LIDAR) sensors, etc.) and eye-facing camera. In some examples, the XR device can generate sensor data representations (e.g., a sensor data representation based on the sensor data) of the environment from the scene-facing optical sensors and a user view of the sensor data representation based on the eye-facing camera. In one example, a display of an optical see-through XR device can include a lens or glass in front of each eye (or a single lens or glass over both eyes). The see-through display can allow the user to see a real-world or physical object directly, and can display (e.g., projected or otherwise displayed) an enhanced image of that object or additional AR content (e.g., virtual content overlaid on a sensor data representation of the environment) to augment the user's visual perception of the real world.

Legibility of virtual content can change based on differences and changes in visual characteristics in an environment (e.g., changes in the sensor data representation of the environment). For example, different textures or colors in an environment (real-world or virtual) can affect the legibility of the virtual content overlaid a sensor data representation of the environment. In such an example, the sensor data representation of the environment is an image. For example, the virtual content can be represented within a window overlaid a region of the sensor data representation. The sensor data representation can include different colors, brightness, etc.

For example, legibility of the virtual content can be reduced when the virtual content is of similar or matching color to the sensor data representation (or region of the sensor data representation). In one such example, the virtual content can be red text overlaid a red environment (e.g., a red wall or a red object represented in the sensor data representation of the environment). In such an example, the text can be difficult to read, in part because of a lack in contrast between the red text and the red environment. Further visual characteristics of virtual content and the sensor data representation of the environment can impact legibility of the virtual content. For example, an average luminance, an average gradient, an average texture, an average stereo disparity of a region of the first sensor data representation, and overall brightness of the sensor data representation and the virtual content.

In some examples, regions of the sensor data representation can provide improved legibility of virtual content as compared to other regions of the sensor data representation. For example, the sensor data representation can be an image of an environment with different colored regions or different lighting sources providing varying levels of brightness in regions of the sensor data representation. For example, the environment can include a blue region and a red region, such as a blue wall and a red wall. In such an example, a first example of virtual content can be legible when overlaid the blue region but illegible over the red region. A second example of virtual content can be legible when overlaid the red region.

In such examples, HMD can provide virtual content management features. For example, an HMD can control or recommend placement of virtual content within an environment based on the legibility of the virtual content. In other examples, the HMD can detect objects and surfaces within an environment. The HMD can virtually mount (e.g., attach virtually) virtual content to objects or surfaces within an environment. The HMD can include virtual content management features to maintain the virtual content in a location within an environment and render the virtual content based on the perspective of the user. For example, the user can virtually mount virtual content, such as a video playing within a virtual window, to a wall of an environment. The user can change position (e.g., walking to another part of the environment, moving his or her head to adjust perspective, etc.). In some examples, the HMD can render the virtual content based on the perspective of the user.

Systems, apparatuses, electronic devices, methods (also referred to as processes), and computer-readable media (collectively referred to herein as “systems and techniques”) are described herein for rendering virtual content. For example, the systems and techniques are described herein for rendering virtual content within an HMD. For example, the HMD can provide VR, XR, AR, MR, etc. environments.

In some aspects, the HMD can include various optical sensors or cameras. For example, the HMD can include scene-facing cameras to generate sensor data representations of a real-world environment. The HMD can include eye-facing (also referred to as eye-tracking) cameras to track user point of view of the sensor data representation. The HMD can use the scene-facing cameras to generate a sensor data representation of the real-world environment such as images, video, etc. In some examples, the sensor data representation can be a three-dimensional mesh representation of the real-world environment. In further examples, the sensor data representation can include depth data, such as depth data measured by a ranging sensor or determined based on a comparison of images generated by a plurality of cameras. For example, the sensor data representation can be represented as pixels or voxels.

In some aspects, the HMD (or component thereof) can render the sensor data representation using eye-perspective rendering (EPR) as input. The sensor data representation generated using EPR can represent the user view of the real-world scene as seen through the HMD. The sensor data representation can be generated using additional HMD data such as eye and head poses of the user. In some aspects, the HMD can generate left and right eye views of images (e.g., frames in a video) using reprojection of RGB images and depth data (or the spatial mesh) as proxy geometry for rendering the sensor data representation with depth.

In some aspects, the systems and techniques can include processing the sensor data representation of the environment to determine visual characteristics associated with the sensor data representation (also referred to as visual characteristics of the environment at least because the sensor data representation can be a representation of the real-world environment of the user). For example, visual characteristics of the sensor data representation (or regions of the sensor data representation) can include luminance, gradient magnitude, texture, color, and overall brightness of the environment. In some examples, regions of the sensor data representation can be associated with various objects represented within the sensor data representation.

For example, where the sensor data representation is an image of a room, a first region can be associated with a first wall of the room, a second region can be associated with a second wall of the room, a third region can be associated with an object in the room (e.g., a couch, a cabinet), etc. In other examples, the regions can be associated with an area within the sensor data representation having similar visual characteristics. For example, a first region of the sensor data representation can include an area having substantially a first color, texture, brightness, etc. A second region can include an area having substantially a second color, texture, brightness, etc.

In such examples, luminance can include an amount of light reflected from a surface in an environment. In some examples, luminance can be used to identify texture of objects within the sensor data representation. For example, different textures can have different luminance patterns (e.g., levels of brightness from reflected light). In some examples, the HMD can identify the difference in luminance of an object. In other examples, luminance can indicate directions of light sources, changes in perspective angles of a user, etc. In some aspects, the luminance can be determined at a pixel level based on RGB values of individual pixels. In some examples, the HMD can determine an average luminance value of regions of the sensor data representation.

In some aspects, gradient magnitude can represent changes in light intensity of regions of the sensor data representation. In some examples, the gradient magnitude can be determined based on a pixel-by-pixel comparison of RGB values. In further examples, gradient magnitude can be used to identify edges of objects or regions in the sensor data representation. For example, a change in gradient magnitude exceeding a predetermined threshold can represent an edge of an object. In other examples, the gradient magnitude can be determined using image processing techniques such as application of a Sobel filter. For example, the Sobel filter can be used to determine gradient in multiple directions using a predetermined convolution kernel size (e.g., one or more 3×3 convolution kernels). Each kernel can be convolved with the sensor data representation to determined directional gradients (e.g., horizontal, vertical, oblique, etc.).

In some aspects, the texture of the sensor data representation (or objects represented in the sensor data representation and regions of the sensor data representation) can be determined by applying a Gabor filter to pixels of the sensor data representation. For example, the Gabor filter can determine spatial frequency and variations in light intensity of the sensor data representation to identify patterns corresponding to different textures of objects represented in the sensor data representation. For example, the sensor data representation can include a wooden wall and a metal table. In some examples, the HMD (or component thereof) can identify a difference in texture between objects within the sensor data representation based on the spatial frequency and variations in light intensity using a Gabor filter.

In some aspects, the systems and techniques can include comparing visual characteristics of virtual content to the visual characteristics of the sensor data representation. For example, the virtual content can be an image with various colors, textures, brightness, etc. In other examples, the virtual content can be text with various spacing, font, color, etc. The systems and techniques can include comparing visual characteristics of the virtual content and the sensor data representation to determine whether the virtual content meets a legibility threshold to be overlaid a region of the sensor data representation.

For example, the user can select to display virtual content, such as a text. The systems and techniques can include determining where within the sensor data representation, to overlay the virtual content based on the legibility. In further examples, the systems and techniques can include adjusting the virtual content based on where the virtual content is overlaid based on a comparison of visual characteristics (e.g., to improve legibility).

For example, the systems and techniques can use EPR views to evaluate the real-world background behind already placed windows (e.g., already placed virtual content) with respect to text legibility and adjust the virtual content. In further examples, the systems and techniques can include determining an area (e.g., recommending or generating a recommendation) with legibility above a legibility threshold where the virtual content can be positioned. In some examples, the legibility threshold can be a value which when exceeded, the systems and techniques can determine to adjust the virtual content. For example, the legibility threshold can be a value based on visual characteristics of the environment and the virtual content, or a value based on a comparison of the visual characteristics of the environment and the virtual content. For example, the systems and techniques can have multiple legibility thresholds associated with various visual characteristics, such as color, luminance, brightness, textures, etc. In another example, the legibility threshold can be an overall legibility threshold associated with multiple visual characteristics of the environment (represented in the sensor data representation) and the visual characteristics of the virtual content. In some examples, the systems and techniques can generate one or more legibility values associated with visual characteristics of the virtual content, the visual characteristics of the sensor data representation, or values associated with the comparison of visual characteristics of the virtual content and the sensor data representation. The systems and techniques can include comparing the generated legibility value to the legibility threshold.

In such an example, EPR views can be determined on a pixel-by-pixel basis with respect to criteria (e.g., the comparison of the visual characteristics) which can negatively impact text legibility, such as brightness levels, colors, textures, etc. The systems and techniques can store the criteria and results of the comparison for each pixel of the sensor data representation.

Example criteria for determining legibility of virtual content overlaid a sensor data representation can include average luminance. In regions of the sensor data representation which are brighter than the virtual content can cause the virtual content to be illegible. Regions lacking substantially uniform textures can reduce legibility of virtual content. In such examples, the systems and techniques can include avoiding placing virtual content in regions brighter than the virtual content or in regions with non-uniform textures. In further examples, the systems and techniques can determine to adjust the virtual content, place the virtual content, or avoid placing the virtual content based on stereo disparity of a region of the sensor data representation. For example, in examples such as vertical stripes which can reduce legibility of virtual content. In another example, the stereo disparity can depend on distance of the user to the virtual content.

In some aspects, applying the criteria (e.g., comparing the visual characteristics of the sensor data representation and the virtual content) to virtual content can include determining an average of pixels overlapped by the virtual content. For example, the systems and techniques can determine averaged criteria (e.g., average luminance, color, texture, stereo disparity, gradient magnitude, etc.). The systems and techniques can include determining legibility of the virtual content based on what region of the sensor data representation the virtual content overlays.

In some aspects, the systems and techniques can include adjusting the virtual content based on the comparison of the visual characteristics. For example, the systems and techniques can adjust the virtual content to increase legibility. Adjustments can include adjusting brightness of the virtual content, increasing size, recommending different positions to place the virtual content, etc. In examples where the virtual content can include text, the adjustments can include adjusting spacing, font size, text color, etc. of the text. In some examples, the adjustments can include applying a background to the virtual content or adjusting a background of the virtual content. For example, the systems and techniques can include adjusting transparency, color, and brightness of a background.

In some aspects, the systems and techniques can include generating a recommendation of a location to place virtual content based on the comparison of visual characteristics. For example, the systems and techniques can include generating virtual windows which the user can determine to place virtual content. In other examples, the systems and techniques can automatically place the virtual content based on the comparison of visual characteristics. In some aspects, the user can select to place the virtual content as recommended. In some examples, the systems and techniques can include recommending placement locations and angles for virtual content. Additionally or alternatively, in some examples, the systems and techniques can include restricting placement options of virtual content. For instance, the systems and techniques can include restricting placement options for virtual content based on visual characteristics of the virtual content and the environment.

In further aspects, the systems and techniques can adjust the virtual content further based on a change in the sensor data representation or change in perspective of the user. For example, lighting in an environment can be dynamic, the virtual content can change, etc. The systems and techniques can include adjusting the virtual content based on changes in visual characteristics of the sensor data representation and the virtual content.

Various aspects of the systems and techniques described herein will be discussed below with respect to the figures.

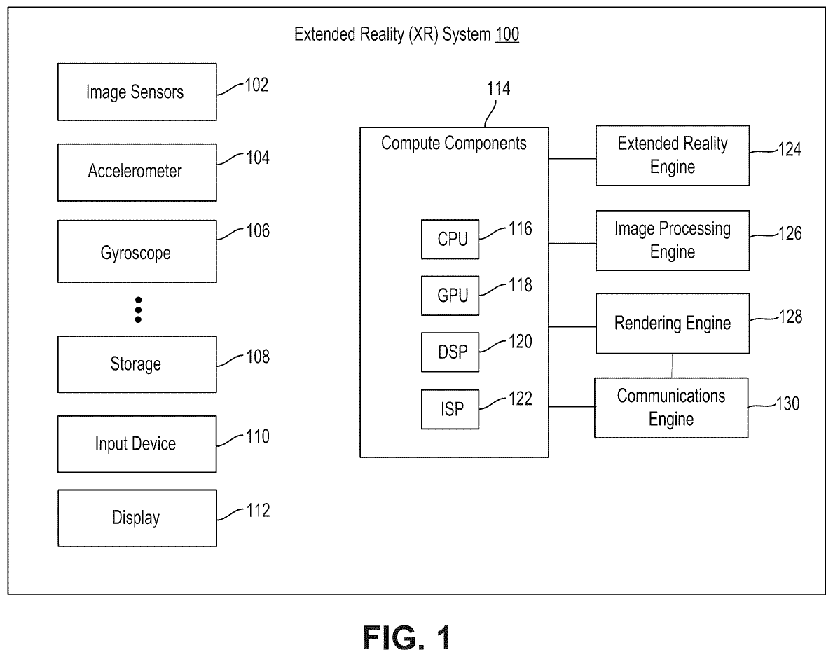

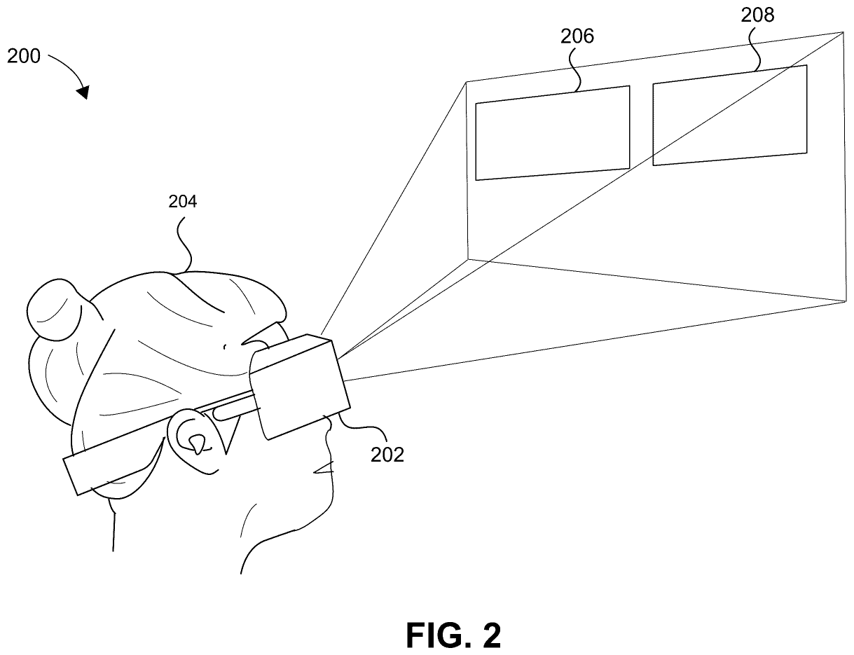

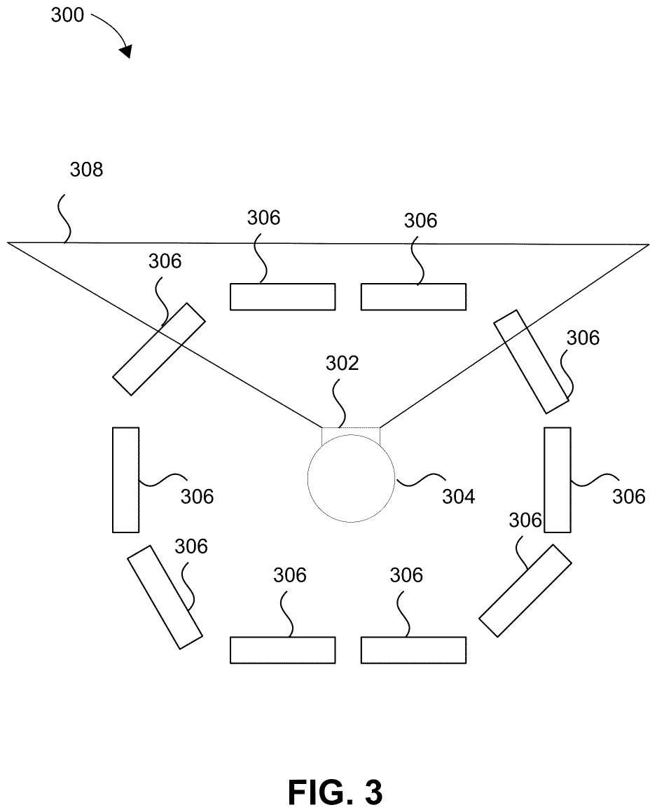

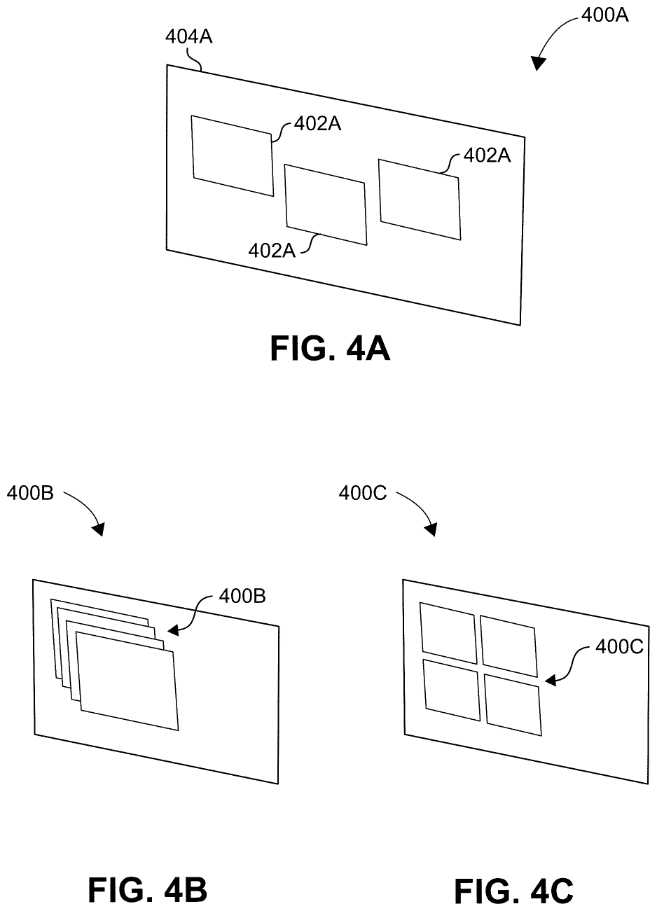

FIG. 1 is a diagram illustrating an architecture of an example extended reality (XR) system 100, in accordance with some aspects of the disclosure. XR system 100 may execute XR applications and implement XR operations. XR system 100 may be an example of, or be included in, any of the HMD of referenced in FIG. 2, FIG. 3, FIGS. 4A-4C, FIG. 5, FIG. 6, and FIG. 7.

In this illustrative example, XR system 100 includes one or more image sensors 102, an accelerometer 104, a gyroscope 106, storage 108, an input device 110, a display 112, Compute components 114, an XR engine 126, an image processing engine 128, a rendering engine 130, and a communications engine 132. It should be noted that the components 102-132 shown in FIG. 1 are non-limiting examples provided for illustrative and explanation purposes, and other examples may include more, fewer, or different components than those shown in FIG. 1. For example, in some cases, XR system 100 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 1. While various components of XR system 100, such as image sensor 102, may be referenced in the singular form herein, it should be understood that XR system 100 may include multiple of any component discussed herein (e.g., multiple image sensors 102).

Display 112 can be, or can include, a glass, a screen, a lens, a projector, and/or other display mechanism that allows a user to see the real-world environment and also allows virtual content to be overlaid, overlapped, blended with, or otherwise displayed thereon.

XR system 100 can include, or can be in communication with, (wired or wirelessly) an input device 110. Input device 110 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 102 can capture images that may be processed for interpreting gesture commands.

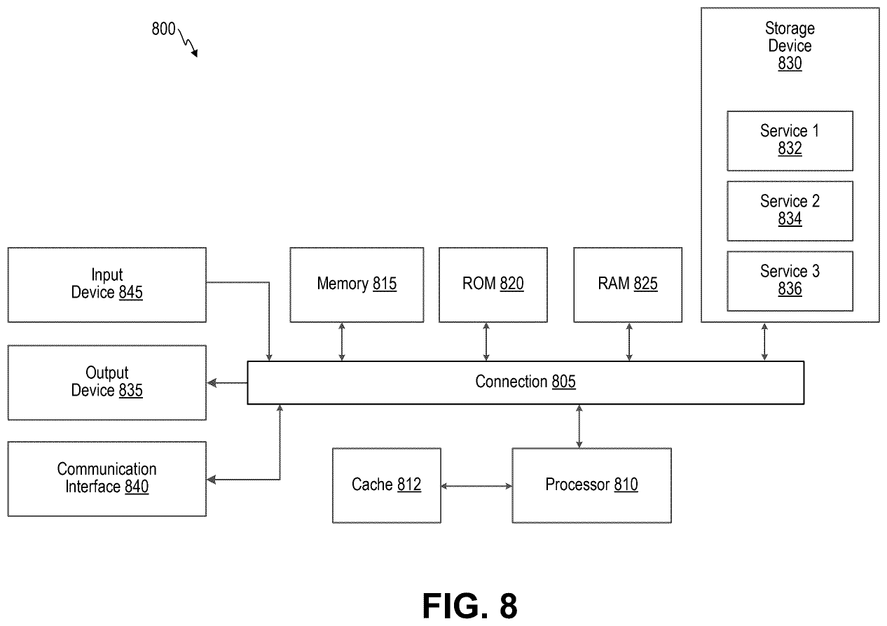

XR system 100 can also communicate with one or more other electronic devices (wired or wirelessly). For example, communications engine 132 can be configured to manage connections and communicate with one or more electronic devices. In some cases, communications engine 132 can correspond to communication interface 826 of FIG. 8.

In some implementations, image sensors 102, accelerometer 104, gyroscope 106, storage 108, display 112, compute components 114, XR engine 126, image processing engine 128, and rendering engine 130 can be part of the same computing device. For example, in some cases, image sensors 102, accelerometer 104, gyroscope 106, storage 108, display 112, compute components 114, XR engine 126, image processing engine 128, and rendering engine 130 may be integrated into an HMD, extended reality glasses, smartphone, laptop, tablet computer, gaming system, and/or any other computing device. However, in some implementations, image sensors 102, accelerometer 104, gyroscope 106, storage 108, display 112, compute components 114, XR engine 126, image processing engine 128, and rendering engine 130 may be part of two or more separate computing devices. For instance, in some cases, some of the components 102-132 may be part of, or implemented by, one computing device and the remaining components can be part of, or implemented by, one or more other computing devices. For example, such as in a split perception XR system, XR system 100 can include a first device (e.g., an HMD), including display 112, image sensor 102, accelerometer 104, gyroscope 106, and/or one or more compute components 114. XR system 100 may also include a second device including additional compute components 114 (e.g., implementing XR engine 126, image processing engine 128, rendering engine 130, and/or communications engine 132). In such an example, the second device may generate virtual content based on information or data (e.g., images, sensor data such as measurements from accelerometer 104 and gyroscope 106) and can provide the virtual content to the first device for display at the first device. The second device can be, or can include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 108 can be any storage device(s) for storing data. Moreover, storage 108 can store data from any of the components of XR system 100. For example, storage 108 may store data from image sensor 102 (e.g., image or video data), data from accelerometer 104 (e.g., measurements), data from gyroscope 106 (e.g., measurements), data from compute components 114 (e.g., processing parameters, preferences, virtual content, rendering content, scene maps, tracking and localization data, object detection data, privacy data, XR application data, face recognition data, occlusion data, etc.), data from XR engine 126, data from image processing engine 128, and/or data from rendering engine 130 (e.g., output frames). In some examples, storage 108 may include a buffer for storing frames for processing by compute components 114.

Compute components 114 can be or can include a central processing unit (CPU) 116, a graphics processing unit (GPU) 118, a digital signal processor (DSP) 120, an image signal processor (ISP) 122, a neural processing unit (NPU) 124, which may implement one or more trained neural networks, and/or other processors. Compute components 114 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 114 may implement (e.g., control, operate, etc.) XR engine 126, image processing engine 128, and rendering engine 130. In other examples, compute components 114 may also implement one or more other processing engines.

Image sensor 102 can include any image and/or video sensors or capturing devices. In some examples, image sensor 102 can be part of a multiple-camera assembly, such as a dual-camera assembly. Image sensor 102 can capture image and/or video content (e.g., raw image and/or video data), which can then be processed by compute components 114, XR engine 126, image processing engine 128, and/or rendering engine 130 as described herein.

In some examples, image sensor 102 can capture image data and can generate images (also referred to as frames) based on the image data and/or may provide the image data or frames to XR engine 126, image processing engine 128, and/or rendering engine 130 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 102 (and/or other camera of XR system 100) can be configured to also capture depth information. For example, in some implementations, image sensor 102 (and/or other camera) may include an RGB-depth (RGB-D) camera. In some cases, XR system 100 can include one or more depth sensors (not shown) that are separate from image sensor 102 (and/or other camera) and that may capture depth information. For instance, such a depth sensor may obtain depth information independently from image sensor 102. In some examples, a depth sensor may be physically installed in the same general location or position as image sensor 102 but may operate at a different frequency or frame rate from image sensor 102. In some examples, a depth sensor may take the form of a light source that may project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 100 can also include other sensors in its one or more sensors. The one or more sensors may include one or more accelerometers (e.g., accelerometer 104), one or more gyroscopes (e.g., gyroscope 106), and/or other sensors. The one or more sensors may provide velocity, orientation, and/or other position-related information to compute components 114. For example, accelerometer 104 may detect acceleration by XR system 100 and may generate acceleration measurements based on the detected acceleration. In some cases, accelerometer 104 may provide one or more translational vectors (e.g., up/down, left/right, forward/back) that may be used for determining a position or pose of XR system 100. Gyroscope 106 can detect and measure the orientation and angular velocity of XR system 100. For example, gyroscope 106 may be used to measure the pitch, roll, and yaw of XR system 100. In some cases, gyroscope 106 may provide one or more rotational vectors (e.g., pitch, yaw, roll). In some examples, image sensor 102 and/or XR engine 126 may use measurements obtained by accelerometer 104 (e.g., one or more translational vectors) and/or gyroscope 106 (e.g., one or more rotational vectors) to calculate the pose of XR system 100. As previously noted, in other examples, XR system 100 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of XR system 100, using a combination of one or more accelerometers, one or more gyroscopes, and/or one or more magnetometers. In some examples, the one or more sensors may output measured information associated with the capture of an image captured by image sensor 102 (and/or other camera of XR system 100) and/or depth information obtained using one or more depth sensors of XR system 100.

The output of one or more sensors (e.g., accelerometer 104, gyroscope 106, one or more IMUs, and/or other sensors) can be used by XR engine 126 to determine a pose of XR system 100 (also referred to as the head pose) and/or the pose of image sensor 102 (or other camera of XR system 100). In some cases, the pose of XR system 100 and the pose of image sensor 102 (or other camera) can be the same. The pose of image sensor 102 refers to the position and orientation of image sensor 102 relative to a frame of reference (e.g., field of view of the camera). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 102 to track a pose (e.g., a 6DoF pose) of XR system 100. For example, the device tracker can fuse visual data (e.g., using a visual tracking solution) from the image data with inertial data from the measurements to determine a position and motion of XR system 100 relative to the physical world (e.g., the scene) and a map of the physical world. As described below, in some examples, when tracking the pose of XR system 100, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 100 within the scene and the 3D map of the scene, etc. The 3D map can provide a digital representation of a scene in the real/physical world. In some examples, the 3D map can anchor position-based objects and/or content to real-world coordinates and/or objects. XR system 100 can use a mapped scene (e.g., a scene in the physical world represented by, and/or associated with, a 3D map) to merge the physical and virtual worlds and/or merge virtual content or objects with the physical environment.

In some aspects, the pose of image sensor 102 and/or XR system 100 as a whole can be determined and/or tracked by compute components 114 using a visual tracking solution based on images captured by image sensor 102 (and/or other camera of XR system 100). For instance, in some examples, compute components 114 can perform tracking using computer vision-based tracking, model-based tracking, and/or simultaneous localization and mapping (SLAM) techniques. For instance, compute components 114 can perform SLAM or can be in communication (wired or wireless) with a SLAM system (not shown). SLAM refers to a class of techniques where a map of an environment (e.g., a map of an environment being modeled by XR system 100) is created while simultaneously tracking the pose of a camera (e.g., image sensor 102) and/or XR system 100 relative to that map. The map can be referred to as a SLAM map and can be three-dimensional (3D). The SLAM techniques can be performed using color or grayscale image data captured by image sensor 102 (and/or other camera of XR system 100), and can be used to generate estimates of 6DoF pose measurements of image sensor 102 and/or XR system 100. Such a SLAM technique configured to perform 6DoF tracking can be referred to as 6DoF SLAM. In some cases, the output of the one or more sensors (e.g., accelerometer 104, gyroscope 106, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 102 (and/or other camera) to the SLAM map. For example, 6DoF SLAM can use feature point associations from an input image to determine the pose (position and orientation) of the image sensor 102 and/or XR system 100 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 102 and/or the XR system 100 can be determined by projecting features from the 3D SLAM map into an image or video frame and updating the camera pose from verified 2D-3D correspondences.

In one illustrative example, the compute components 114 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 114 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 100 can also track the hand and/or fingers of the user to allow the user to interact with and/or control virtual content in a virtual environment. For example, the XR system 100 can track a pose, gestures, and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 2 is a block diagram 200 illustrating an example HMD 202 rendering virtual content. For example, the HMD can include a display and one or more optical sensors (e.g., cameras and/or ranging devices). The HMD can generate a sensor data representation of the environment. The HMD can generate virtual content 206 and 208 to place within the sensor data representation.

The HMD can include one or more scene-facing cameras to generate sensor data representations of a real-world environment. In further examples, the HMD can include eye-tracking cameras to track user 204 perspective of the sensor data representation. The HMD can use the scene-facing cameras to generate a sensor data representation of the real-world environment from the perspective of the user 204. Sensor data representations can include images, videos, mesh representations, etc. of the environment and objects in the environment. For example, the sensor data representation can include depth data measured by a ranging sensor such as a LIDAR sensor.

The HMD 202 can render the sensor data representation of the environment and display the sensor data representation to the user on a screen of the HMD. The HMD can monitor user movement within the environment and determine changes in perspective of the user 204 based on detected head movement, changes in position, or eye movements of the user. The HMD 202 can render the sensor data representation using various rendering techniques such as eye-perspective rendering (EPR). In such an example, the HMD 202 can represent the user view of the real-world environment (e.g., as seen through the HMD 202 or through the scene-facing camera of the HMD 202).

The HMD 202 can process the sensor data representation of the environment to determine visual characteristics associated with the sensor data representation. For example, the visual characteristics of the sensor data representation can include data such as the luminance, gradient magnitude, texture, color, and overall brightness of the environment represented in the sensor data representation. In some examples, the sensor data representation is not viewed by the user. For example, the HMD 202 can include a transparent lens which users can view the environment. In other examples, the sensor data representation is displayed to the user on a screen or display of the HMD 202.

In some examples, the visual characteristics of the sensor data representation can be associated with regions of the sensor data representation or individual pixels of the sensor data representation. For example, the sensor data representation can include a representation of an object in the environment with different visual characteristics than another representation of an object. In such examples, the visual characteristics of regions of the sensor data representation can differ. For example, a first region of an environment can have different color, texture, brightness, etc. The HMD 202 can determine locations to place virtual content within the sensor data representation.

The HMD 202 can use pixel characteristics (e.g., pixel values) of pixels of the sensor data representation to determine the visual characteristics of the sensor data representation. For example, the HMD 202 can use RGB values of individual pixels or groups of pixels to determine visual characteristics of the sensor data representation such as the luminance, brightness, color, etc. The HMD 202 can use pixel characteristics of pixels of the virtual content to determine visual characteristics of the virtual content. In some examples, the virtual content can include information or metadata associated with visual characteristics of the virtual data. For example, the virtual data can be text. The virtual content can include visual characteristics associated with the font, size, spacing, color, etc. of the text. In some examples, the virtual content can be represented in a virtual window.

The HMD 202 can determine where to place the virtual content 206 and 208 based on a comparison of the visual characteristics of the virtual content and visual characteristics of the sensor data representation. For example, the HMD 202 can compare colors of the virtual content 206 and colors of regions of the sensor data representation to determine locations within the sensor data representation to place (or not to place) the virtual content 206 and 208.

In some examples, the HMD 202 can compare visual characteristics of the virtual content 206 and 208 with visual characteristics of the sensor data representation to determine a level of legibility of the virtual content when overlaid a region of the sensor data representation. For example, the virtual content can be an image, text, or video with various colors, textures, brightness, etc. The HMD 202 can determine, based on the comparison of visual characteristics, whether the virtual content meets a legibility threshold to overlay the virtual content over a region of the sensor data representation.

In further examples, the HMD 202 can adjust the virtual content 206 and 208 based on the comparison of the visual characteristics. For example, the HMD 202 can determine the virtual content 206 and 208 is not legible because the colors of the virtual content and the sensor data representation do not provide enough contrast. For example, the virtual content can be a text with red letters overlaid on a red region of the sensor data representation. In such an example, the HMD 202 can adjust the virtual content by adjusting the color of the text (e.g., change from red to white).

In further examples, the HMD 202 can adjust the virtual content by adding a background to the virtual content. For example, the background can be semi-transparent (e.g., translucent) with a color to provide contrast between the virtual content and the background. For example, where the virtual content is red text overlaid on a red region of the sensor data representation, the HMD 202 can generate a background behind the virtual content to improve legibility (e.g., placing a white background to make the virtual content legible).

In further examples, the HMD 202 can generate recommendations for locations or positions to render virtual content within the sensor data representation. For example, the user 204 can select from a plurality of recommended positions a position to render the virtual content. In further examples, the HMD 202 can automatically render the virtual content based on a location the HMD 202 determines the virtual content is legible (e.g., based on the comparison of visual characteristics).

In further examples, the HMD 202 can dynamically render the virtual content based on changes in the sensor data representation or changes in perspective of the user 204. For example, virtual content can be legible from a first perspective, but illegible from a different perspective. In such an example, the HMD 202 can detect changes in location, orientation, and perspective of the user 204. The HMD 202 can update the virtual content based on the changes. In some examples, the virtual content can be moved in location based on a change in legibility of the virtual content from a changed user perspective.

In further examples, the sensor data representation can change. For example, a light source in an environment can be turned on, objects can be moved, etc. In such an example, the HMD 202 can update the virtual content (e.g., position of the virtual content or the visual characteristics of the virtual content) based on the changes in the environment or sensor data representation.

FIG. 3 is a block diagram 300 illustrating example locations for positioning virtual content. For example, the block diagram 300 includes an HMD 302, a user 304, and virtual content positions 306. The block diagram 300 further illustrates a field of view 308 of the user 304 using the HMD 302.

By way of non-limiting example, the virtual content positions 306 can be placed in various angles around the user 304 within the environment. The HMD 302 can track the location of virtual content including when the virtual content is not within a field of view of the user 304. For example, the user 304 can select virtual content positions 306 to place virtual content. When the user 304 moves position and changes field of view 308, the HMD 302 can track the location of the virtual content within the environment and render the virtual content when the virtual content is within the field of view 308 of the user 304.

In some examples, the HMD 302 can select the virtual content position 306 based on visual characteristics of the virtual content and a sensor data representation of the environment (e.g., images, video, or mesh generated using scene-facing cameras of the HMD 302). In such an example, the HMD 302 can automatically place virtual content in a virtual content position based on the visual characteristics. In some examples, the HMD 302 can match virtual content to a virtual content position based on legibility of the virtual content at the virtual content position.

FIG. 4A. 4B, and 4C illustrate examples of virtual content positions where an HMD can determine to position virtual content. For example, FIG. 4A is a block diagram 400A illustrating an example of virtually mounting virtual content 402A to a wall 404A. FIG. 4B is a block diagram 400B illustrating generating a stack of virtual content 402B snapped (e.g., anchored) to a wall. For example, the virtual content can be represented in virtual windows. An HMD can layer the virtual windows to generate a stack of virtual content 402B. A user can select, from the stack of virtual content 402B which virtual content to be displayed or positioned within a sensor data representation. FIG. 4C is a block diagram 400C illustrating an example of organizing virtual content into a grid 402C snapped (e.g., anchored) to a wall.

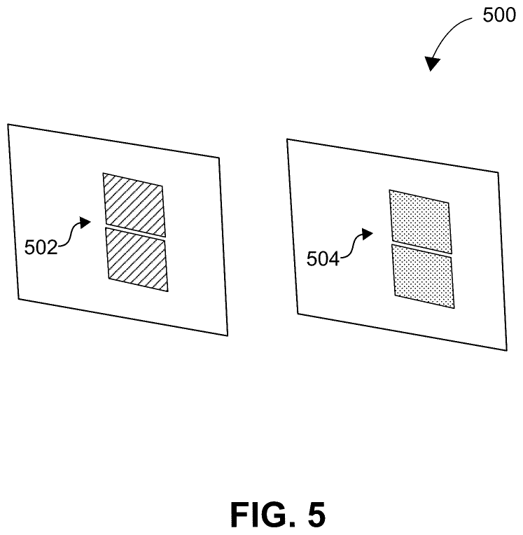

FIG. 5 is a block diagram 500 illustrating an example of adjustments to virtual content to improve legibility. For example, FIG. 5 includes a first set of virtual content 502 and a second set of virtual content 504. As illustrated in FIG. 5, the brightness of the virtual content can be increased to improve legibility. For example, the second set of virtual content 504 can be the same virtual content as the first set of virtual content 502 with increased brightness. The increased contrast can provide an increased contrast between the virtual content and a sensor data representation of the environment, which can increase legibility of the virtual content.

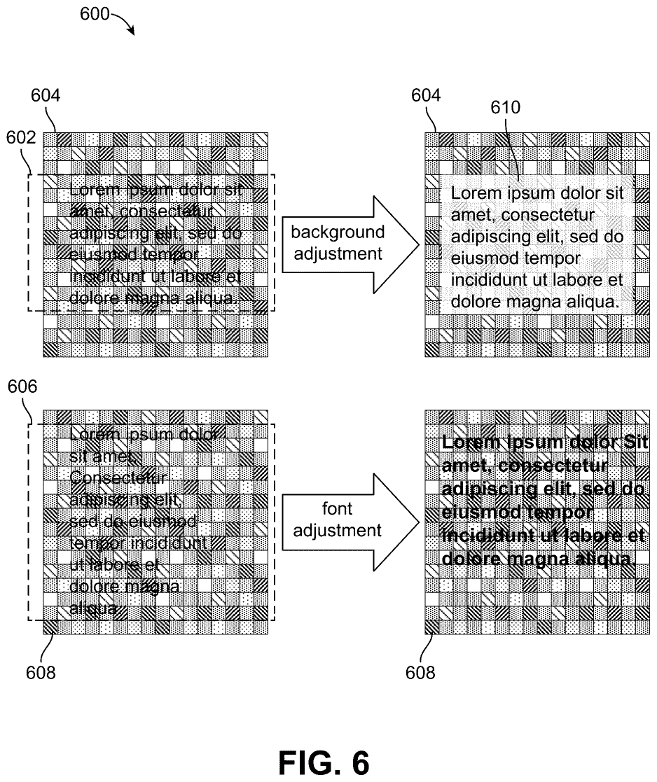

FIG. 6 is a block diagram 600 illustrating example adjustments to virtual content to improve legibility. For example, FIG. 6 illustrates a first set of virtual content 602 (e.g., text overlaid on an image 604) and a second set of virtual content 606 (e.g., text overlaid on an image 608). As illustrated in the first set of virtual content 602, an addition of a background 610 can improve legibility of the virtual content by providing more uniform contrast and greater contrast between the virtual content 602 and the image 608.

FIG. 6 illustrates an example of improvements to legibility of the second set of virtual content 606 by adjustments to font of the second set of virtual content 606. For example, the font adjustment includes increase in font size, increase in brightness of the font, and adjustment in spacing of the text to improve legibility.

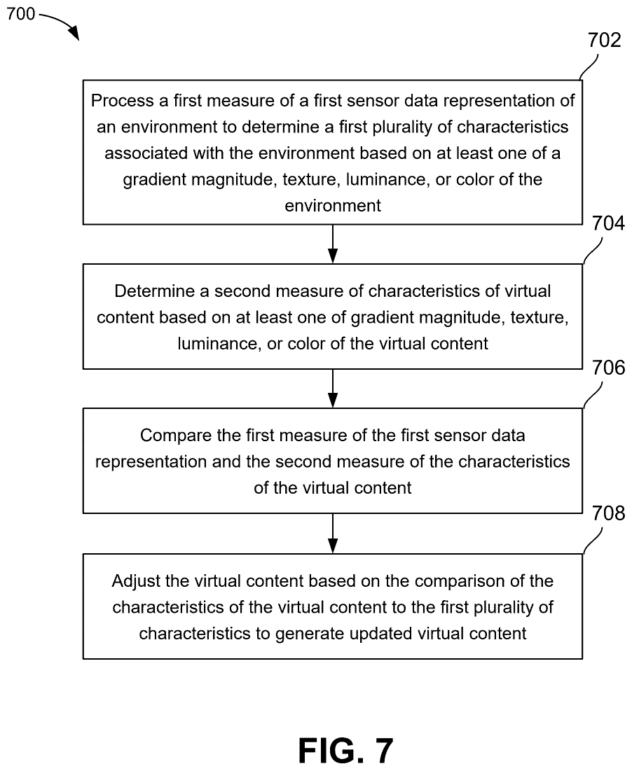

FIG. 7 is a flow diagram illustrating an example process 700 for rendering virtual content. In particular, the process 700 illustrates an example process of rendering virtual content to improve legibility based on a sensor data representation of an environment using an HMD, such as the XR system 100 of FIG. 1, the HMD 202 of FIG. 2, the HMD 302 of FIG. 3, etc. The process 700 can be performed by a computing device (e.g., the XR system 100 of FIG. 1, the HMD 202 of FIG. 2, the HMD 302 of FIG. 3, the computing device or computing system 800 of FIG. 8, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 700 can be implemented as software components that are executed and run on one or more processors (e.g., the compute components 114 of FIG. 1, the processor 810 of FIG. 8, or other processor(s)) of the computing device.

At block 702, the computing device (or component thereof) can process a first measure of a first sensor data representation of an environment to determine a first plurality of characteristics associated with the environment based on at least one of a gradient magnitude, texture, luminance, or color of the environment. For example, the first sensor data representation can be generated using images generated by scene-facing cameras of the computing device (or other device such as an HMD). In some examples, the sensor data representation can be a three-dimensional mesh representation of the real-world environment. In further examples, the sensor data representation can include depth data, such as depth data measured by a ranging sensor or determined based on a comparison of images generated by a plurality of cameras. In some examples, the sensor data representation can be represented as pixels or voxels.

At block 704, the computing device (or component thereof) can determine a second measure of characteristics of virtual content based on at least one of gradient magnitude, texture, luminance, or color of the virtual content. In some examples, the virtual content can include text. In further examples, the virtual content can be represented in a virtual window. In some examples, the virtual content can be a virtual object. In another example, the virtual content can be a video in a virtual window.

At block 706, the computing device (or component thereof) can compare the first measure of the first sensor data representation and the second measure of the characteristics of the virtual content. In some examples, the comparison can include a determination of legibility of the virtual content (such as when the virtual content includes text) overlaid a region of the first sensor data representation of the environment. In some examples, the determination of legibility can be based on a measure of luminance, a color or intensity gradient, a texture, and stereo disparity of the region of the first sensor data representation. In further examples, the determination of legibility can be based on an overall brightness of the first sensor data representation. In some examples, the computing device (or component thereof) can determine, based on the comparison, whether the virtual content exceeds a legibility threshold. For example, the legibility threshold can be a value based on characteristics of the environment and the virtual content, or a value based on a comparison of the characteristics of the environment and the virtual content. In some examples, the systems and techniques can generate one or more legibility values associated with characteristics of the virtual content, the characteristics of the sensor data representation, or legibility values associated with the comparison of characteristics of the virtual content and the sensor data representation. The computing device (or component thereof) can compare the generated legibility value to the legibility threshold.

At block 708, the computing device (or component thereof) adjust the virtual content based on the comparison of the characteristics of the virtual content to the first plurality of characteristics to generate updated virtual content. In some examples, the computing device (or component thereof) can determine a region of the first sensor data representation to place the updated virtual content based on the comparison. In another example, the computing device (or component thereof) can determine a region of the first sensor data representation to place the updated virtual content based on the comparison. For example, the first sensor data representation can represent an environment. The region can be an area, location, or plane within the environment in which the updated virtual content can be located. In another example, the computing device (or component thereof) can adjust the virtual content such as by adjusting transparency of the virtual window. In a further example, the computing device (or component thereof) can adjust a color of the virtual window. In such an example, a region of the first sensor data representation can include a first color. The virtual content to be rendered at the region can include the first color. In such an example, the computing device (or component thereof) can adjust the color of the virtual window to improve legibility of the virtual content represented in the virtual window. In further examples, the computing device (or component thereof) can adjust font, spacing, color, and brightness of the virtual content (such as text). The computing device (or component thereof) can display adjusted virtual content (e.g., updated virtual content) in the virtual window.

In some examples, the computing device (or component thereof) can generate a recommendation of a region of the first sensor data representation to place the updated virtual content based on the comparison. The computing device (or component thereof) can receive a selection to place the updated virtual content based on the recommendation. In some examples, the recommendation can include one or more options for regions to place the updated virtual content. Users can select one of the options to place the updated virtual content.

In another example, the computing device (or component thereof) can determine to adjust the virtual content based on the comparison of the first measure and the second measure exceeding a legibility threshold. In some examples, the first measure of the first sensor data representation includes a weighted sum of luminance, gradient magnitude, texture, and color of the environment. In another example, the second measure of the characteristics of the virtual content includes a weighted sum of luminance, gradient magnitude, texture, and color of the virtual content. In further examples, the comparison of the first measure and the second measure includes a comparison of a first portion of the first measure of the first sensor data representation and the second measure of the characteristics of the virtual content. In such an example, the first portion can be associated with a first region of the environment in which the virtual content is represented. In further examples, the second portion can be associated with a second region of the environment. The computing device (or component thereof) can compare a second portion of the first measure and the second measure and adjust the virtual content based on the comparison. In another example, adjustments to the virtual content can include adjustments to a size, color, or a location of the virtual content.

In another example, the computing device (or component thereof) can determine a change in perspective of a user within the environment. For example, users can move within an environment represented in the sensor data representation. The user movement can provide the user with a different perspective of the environment. The computing device (or component thereof) can process a second sensor data representation of the environment associated with the change in the perspective of the user to determine a second plurality of characteristics associated with the second sensor data representation. In such an example, the computing device (or component thereof) can compare characteristics of the updated virtual content to the second plurality of characteristics. For example, characteristics can include information such as brightness, luminance, color, etc. of the updated virtual content. The computing device (or component thereof) can adjust the updated virtual content based on the comparison of the characteristics of the updated virtual content to the second plurality of characteristics.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 825, such as read-only memory (ROM) 820 and random access memory (RAM) 825 to processor 810. Computing system 800 may include a cache 815 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with the computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for rendering virtual content, comprising: at least one memory; and at least one processor coupled to the at least one memory, the at least one processor configured to: process a first measure of a first sensor data representation of an environment to determine a first plurality of characteristics associated with the environment based on at least one of a gradient magnitude, texture, luminance, or color of the environment; determine a second measure of characteristics of virtual content based on at least one of gradient magnitude, texture, luminance, or color of the virtual content; compare the first measure of the first sensor data representation and the second measure of the characteristics of the virtual content; and adjust the virtual content based on the comparison of the characteristics of the virtual content to the first plurality of characteristics to generate updated virtual content.
Aspect 2. The apparatus of Aspect 1, wherein the at least one processor is configured to: display the updated virtual content in a virtual window.
Aspect 3. The apparatus of any of Aspects 1 to 2, wherein the at least one processor is configured to: determine a region of the first sensor data representation to place the updated virtual content based on the comparison.
Aspect 4. The apparatus of any of Aspects 1 to 3, wherein the at least one processor is configured to: generate a recommendation of a region of the first sensor data representation to place the updated virtual content based on the comparison; and receive a selection to place the updated virtual content based on the recommendation.
Aspect 5. The apparatus of any of Aspects 1 to 4, wherein, to adjust the virtual content, the at least one processor is configured to adjust transparency of the virtual window.
Aspect 6. The apparatus of any of Aspects 1 to 5, wherein, to adjust the virtual content, the at least one processor is configured to adjust a color of the virtual window.
Aspect 7. The apparatus of any of Aspects 1 to 6, wherein the at least one processor is configured to: determine to adjust the virtual content based on the comparison of the first measure and the second measure exceeding a legibility threshold.
Aspect 8. The apparatus of any of Aspects 1 to 7, wherein the first measure of the first sensor data representation includes a weighted sum of luminance, gradient magnitude, texture, and color of the environment.
Aspect 9. The apparatus of any of Aspects 1 to 8, wherein the second measure of the visual characteristics of the virtual content includes a weighted sum of luminance, gradient magnitude, texture, and color of the virtual content.
Aspect 10. The apparatus of any of Aspects 1 to 9, wherein the comparison of the first measure and the second measure includes a comparison of a first portion of the first measure of the first sensor data representation and the second measure of the visual characteristics of the virtual content, wherein the first portion is associated with a first region of the environment in which the virtual content is represented.
Aspect 11. The apparatus of any of Aspects 1 to 10, wherein the at least one processor is configured to: compare a second portion of the first measure and the second measure, wherein the second portion is associated with a second region of the environment; adjust the virtual content based on the comparison.
Aspect 12. The apparatus of any of Aspects 1 to 11, wherein, to adjust the virtual content, the at least one processor is configured to adjust a size, color, or a location of the virtual content.
Aspect 13. The apparatus of any of Aspects 1 to 12, wherein the virtual content includes text, and to adjust the virtual content, the at least one processor is configured to adjust font, spacing, color, and brightness of the text.
Aspect 14. The apparatus of any of Aspects 1 to 13, wherein the comparison includes a determination of legibility of the text overlaid a region of the first sensor data representation of the environment.
Aspect 15. The apparatus of any of Aspects 1 to 14, wherein the determination of the legibility is based on a measure of luminance, a color or intensity gradient, a texture, and stereo disparity of the region of the first sensor data representation.
Aspect 16. The apparatus of any of Aspects 1 to 15, wherein the determination of the legibility is further based on an overall brightness of the first sensor data representation.
Aspect 17. The apparatus of any of Aspects 1 to 16, wherein the at least one processor is configured to: determine a change in perspective of a user within the environment; process a second sensor data representation of the environment associated with the change in the perspective of the user to determine a second plurality of visual characteristics associated with the second sensor data representation; compare visual characteristics of the updated virtual content to the second plurality of visual characteristics; and adjust the updated virtual content based on the comparison of the visual characteristics of the updated virtual content to the second plurality of visual characteristics.
Aspect 18. A method comprising: processing a first measure of a first sensor data representation of an environment to determine a first plurality of characteristics associated with the environment based on at least one of a gradient magnitude, texture, luminance, or color of the environment; determining a second measure of characteristics of virtual content based on at least one of gradient magnitude, texture, luminance, or color of the virtual content; comparing the first measure of the first sensor data representation and the second measure of the characteristics of the virtual content; and adjusting the virtual content based on the comparison of the characteristics of the virtual content to the first plurality of characteristics to generate updated virtual content.
Aspect 19. The method of Aspect 18, wherein the at least one processor is configured to: displaying the updated virtual content in a virtual window.
Aspect 20. The method of any of Aspects 18 to 19, wherein the at least one processor is configured to: determining a region of the first sensor data representation to place the updated virtual content based on the comparison.
Aspect 21. The method of any of Aspects 18 to 20, wherein the at least one processor is configured to: generating a recommendation of a region of the first sensor data representation to place the updated virtual content based on the comparison; and receiving a selection to place the updated virtual content based on the recommendation.
Aspect 22. The method of any of Aspects 18 to 21, wherein, to adjust the virtual content, the at least one processor is configured to adjust transparency of the virtual window.
Aspect 23. The method of any of Aspects 18 to 22, wherein, to adjust the virtual content, the at least one processor is configured to adjust a color of the virtual window.
Aspect 24. The method of any of Aspects 18 to 23, wherein the at least one processor is configured to: determining to adjust the virtual content based on the comparison of the first measure and the second measure exceeding a legibility threshold.
Aspect 25. The method of any of Aspects 18 to 24, wherein the first measure of the first sensor data representation includes a weighted sum of luminance, gradient magnitude, texture, and color of the environment.
Aspect 26. The method of any of Aspects 18 to 25, wherein the second measure of the visual characteristics of the virtual content includes a weighted sum of luminance, gradient magnitude, texture, and color of the virtual content.
Aspect 27. The method of any of Aspects 18 to 26, wherein the comparison of the first measure and the second measure includes a comparison of a first portion of the first measure of the first sensor data representation and the second measure of the visual characteristics of the virtual content, wherein the first portion is associated with a first region of the environment in which the virtual content is represented.
Aspect 28. The method of any of Aspects 18 to 27, wherein the at least one processor is configured to: comparing a second portion of the first measure and the second measure, wherein the second portion is associated with a second region of the environment; adjusting the virtual content based on the comparison.
Aspect 29. The method of any of Aspects 18 to 28, wherein adjusting the virtual content includes adjusting a size, color, or a location of the virtual content.
Aspect 30. The method of any of Aspects 18 to 29, wherein the virtual content includes text, and adjusting the virtual content includes adjusting font, spacing, color, and brightness of the text.
Aspect 31. The method of any of Aspects 18 to 30, wherein the comparison includes a determination of legibility of the text overlaid a region of the first sensor data representation of the environment.
Aspect 32. The method of any of Aspects 18 to 31, wherein the determination of the legibility is based on a measure of luminance, a color or intensity gradient, a texture, and stereo disparity of the region of the first sensor data representation.
Aspect 33. The method of any of Aspects 18 to 32, wherein the determination of the legibility is further based on an overall brightness of the first sensor data representation.
Aspect 34. The method of any of Aspects 18 to 33, wherein the at least one processor is configured to: determining a change in perspective of a user within the environment; processing a second sensor data representation of the environment associated with the change in the perspective of the user to determine a second plurality of visual characteristics associated with the second sensor data representation; comparing visual characteristics of the updated virtual content to the second plurality of visual characteristics; and adjusting the updated virtual content based on the comparison of the visual characteristics of the updated virtual content to the second plurality of visual characteristics.
Aspect 35. A non-transitory computer-readable medium having stored thereon instructions that, when executed by at least one processor, cause the at least one processor to perform one or more of operations according to any of Aspects 18 to 34.
Aspect 36. An apparatus for rendering virtual content, the apparatus comprising one or more means for performing operations according to any of Aspects 18 to 34.

What is claimed is:

1. An apparatus for rendering virtual content, comprising:
at least one memory; and
at least one processor coupled to the at least one memory, the at least one processor configured to:
process a first measure of a first sensor data representation of an environment to determine a first plurality of characteristics associated with the environment based on at least one of a gradient magnitude, texture, luminance, or color of the environment;
determine a second measure of characteristics of virtual content based on at least one of gradient magnitude, texture, luminance, or color of the virtual content;
compare the first measure of the first sensor data representation and the second measure of the characteristics of the virtual content; and
adjust the virtual content based on the comparison of the characteristics of the virtual content to the first plurality of characteristics to generate updated virtual content.

2. The apparatus of claim 1, wherein the at least one processor is configured to:
display the updated virtual content in a virtual window.

3. The apparatus of claim 2, wherein the at least one processor is configured to:
determine a region of the first sensor data representation to place the updated virtual content based on the comparison.

4. The apparatus of claim 2, wherein the at least one processor is configured to:
generate a recommendation of a region of the first sensor data representation to place the updated virtual content based on the comparison; and
receive a selection to place the updated virtual content based on the recommendation.

5. The apparatus of claim 2, wherein, to adjust the virtual content, the at least one processor is configured to adjust transparency of the virtual window.

6. The apparatus of claim 2, wherein, to adjust the virtual content, the at least one processor is configured to adjust a color of the virtual window.

7. The apparatus of claim 1, wherein the at least one processor is configured to:
determine to adjust the virtual content based on the comparison of the first measure and the second measure exceeding a legibility threshold.

8. The apparatus of claim 1, wherein the first measure of the first sensor data representation includes a weighted sum of luminance, gradient magnitude, texture, and color of the environment.

9. The apparatus of claim 1, wherein the second measure of the characteristics of the virtual content includes a weighted sum of luminance, gradient magnitude, texture, and color of the virtual content.

10. The apparatus of claim 1, wherein the comparison of the first measure and the second measure includes a comparison of a first portion of the first measure of the first sensor data representation and the second measure of the characteristics of the virtual content, wherein the first portion is associated with a first region of the environment in which the virtual content is represented.

11. The apparatus of claim 10, wherein the at least one processor is configured to:
compare a second portion of the first measure and the second measure, wherein the second portion is associated with a second region of the environment; and
adjust the virtual content based on the comparison.

12. The apparatus of claim 11, wherein, to adjust the virtual content, the at least one processor is configured to adjust a size, color, or a location of the virtual content.

13. The apparatus of claim 1, wherein the virtual content includes text, and to adjust the virtual content, the at least one processor is configured to adjust font, spacing, color, and brightness of the text.

14. The apparatus of claim 13, wherein the comparison includes a determination of legibility of the text overlaid a region of the first sensor data representation of the environment.

15. The apparatus of claim 14, wherein the determination of the legibility is based on a measure of luminance, a color or intensity gradient, a texture, and stereo disparity of the region of the first sensor data representation.

16. The apparatus of claim 15, wherein the determination of the legibility is further based on an overall brightness of the first sensor data representation.

17. The apparatus of claim 1, wherein the at least one processor is configured to:
determine a change in perspective of a user within the environment;
process a second sensor data representation of the environment associated with the change in the perspective of the user to determine a second plurality of characteristics associated with the second sensor data representation;
compare characteristics of the updated virtual content to the second plurality of characteristics; and
adjust the updated virtual content based on the comparison of the characteristics of the updated virtual content to the second plurality of characteristics.

18. A method comprising:
processing a first measure of a first sensor data representation of an environment to determine a first plurality of characteristics associated with the environment based on at least one of a gradient magnitude, texture, luminance, or color of the environment;
determining a second measure of characteristics of virtual content based on at least one of gradient magnitude, texture, luminance, or color of the virtual content;
comparing the first measure of the first sensor data representation and the second measure of the characteristics of the virtual content; and
adjusting the virtual content based on the comparison of the characteristics of the virtual content to the first plurality of characteristics to generate updated virtual content.

19. The method of claim 18, further comprising:
displaying the updated virtual content in a virtual window.

20. A non-transitory computer-readable medium having stored thereon instructions that, when executed by at least one processor, cause the at least one processor to:
process a first measure of a first sensor data representation of an environment to determine a first plurality of characteristics associated with the environment based on at least one of a gradient magnitude, texture, luminance, or color of the environment;
determine a second measure of characteristics of virtual content based on at least one of gradient magnitude, texture, luminance, or color of the virtual content;
compare the first measure of the first sensor data representation and the second measure of the characteristics of the virtual content; and
adjust the virtual content based on the comparison of the characteristics of the virtual content to the first plurality of characteristics to generate updated virtual content.
